(19) United States
(12) Patent Application Publication
(10) Pub. No.: US 2012/0138426 A1
(43) Pub. Date: Jun. 7, 2012

(54) RECLAIMER MACHINE

(75) Inventor: Marcelo M. CRUZ, Itabira (BR)

(73) Assignee: VALE S/A, Rio de Janeiro (BR)

(21) Appl. No.: 13/274,085

(22) Filed: Oct. 14, 2011

Related U.S. Application Data
(60) Provisional application No. 61/393,063, filed on Oct. 14, 2010.

(51) Int. Cl. B65G 65/06

(52) U.S. Cl. 198/509

(57) ABSTRACT

Aspects of this invention include a reclaimer machine for reclaiming and homogenizing materials such as ore, coal and others, stock-piled in yards. The reclaimer machine may include a bucket wheel having a series of buckets rotating around a shaft, a conveyor belt connected to the bucket wheel and to a transfer chute, the conveyor belt being supported by a mobile upper platform that moves laterally to a pile on tracks attached to a mobile lower platform, wherein a first end of the conveyor belt structure may be connected to the bucket wheel and another end of the conveyor belt structure may be connected to a counterweight which maintains the balance of the reclaimer machine and supports the bucket wheel, upper platform and lower platform movements.

### BACKGROUND OF THE INVENTION

1. Field of Invention

Aspects of the present invention relate to a reclaimer machine for reclaiming and homogenizing materials such as ore, coal and others, either stocked or accumulated in yards.

2. Description of Related Art

The machines currently available for reclaiming and homogenizing materials from stacks in storage yards are generally divided into two models: bridge reclaimer with bucket wheels, and drum reclaimer.

The bridge reclaimer with wheels and bucket is generally divided into three sets: (a) feed system on the stack, (b) system of lateral movement of the bucket wheels and rake and (c) turning system for digging and recovery of stack material. The dynamics of the operation is due by the synchronization of the feed, lateral and turning movement of these sets. As a result of the synchronized movements of these sets, the digging and recovery material from the stack is discharged in the center of the wheel, where there is a conveyor belt internal to the wheel and perpendicular to the stack receiving all the material which in turn gives sequence to the recovered material flow.

A similar setup exists in the case of a drum reclaimer, except that there is no lateral movement because the digging and recovery of the material against the stack occurs through the use of a drum designed with buckets that comprise the entire length of the storage yard, requiring, therefore, two basic movements from the machine, a forward movement towards the stack, and the rotation of the drum that discharges the material into the drum, similarly to the bridge reclaimer with wheels and bucket. There may be a conveyor belt internal to the wheel and perpendicular to the stack that receives the material and gives a sequence to the recovered material flow.

For the reclaimer machines currently available, supporting structures directly linked and supportive of the digging and recovery systems are necessary. They are positioned in locations above, or perpendicularly internal to, these systems. Further, such a configuration uses conveyor belts internal and central to these systems that are perpendicular to the stack. This configuration has the disadvantage of preventing direct access, e.g., for disassembly and assembly of the systems.

### SUMMARY OF THE INVENTION

Various aspects of the present invention include a reclaimer machine that is cost-effective in construction and manufacture, as well as providing advantages with respect to maintenance and repair throughout its life cycle, which significantly reduces operational downtime.

Aspects of this invention also provide a structurally simple reclaimer machine, capable of maintaining the required sturdiness to perform the tasks to which the reclaimer applies.

Aspects of the present invention change and simplify the conventional configurations. The construction and position of the digging and recovery systems in the machine according to aspects of the present invention allow for the free access to the digging and recovery systems because no supporting structures are needed, thus avoiding structures disposed above and/or perpendicularly inside these systems. Furthermore, the conveyor belt (that receives the recovery material from the stack) is not positioned inside and centrally to the digging and recovery systems.

In order to enable these changes, aspects of the reclaimer machine according to the present invention use a counterweight in one end, allowing the use of the support structure (bridge) only in the central part of the machine and thus eliminating the need for using the support structure to support the rotation and lateral movement of the digging and recovery sets required by the current machines. This possibility is due to the fact that in aspects of the present invention, all the support of the front part of the machine—a set of rotation, digging and recovery of material—is sustained in a balance configuration from a central axis. Therefore, such a structure also enables the use of a conveyor belt external to the set of rotation, which is longitudinal to the pile.

According to aspects of the current invention, a reclaimer machine may include a bucket wheel that includes a series of buckets rotating around a shaft, a conveyor belt connected to the bucket wheel and to a transfer chute, the conveyor belt being supported by a mobile upper platform that moves laterally towards a pile of material to be transported on tracks attached to a mobile lower platform, wherein a first end of the conveyor belt structure may be connected to the bucket wheel, and another end of the conveyor belt structure may be connected to a first counterweight that maintains the balance of the reclaimer machine and supports the bucket wheel and upper platform movements.

According to aspects of the current invention, a principle of the machine, which reclaims piles of material and homogenizes the material, is that the machine works by means of forward movements and lateral translation of one or more bucket wheels placed on a horizontal base structure.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 is a schematic view of a reclaimer machine according to various aspects of the current invention;

FIG. 2 is a side view of an aspect of a reclaimer machine according to various aspects of the current invention; and

FIG. 3 is a side view of an aspect of a reclaimer machine according to various aspects of the current invention.

### DETAILED DESCRIPTION OF THE PREFERRED EMBODIMENTS

These and other features and advantages of this invention are described in, or are apparent from, the following detailed description of various exemplary aspects.

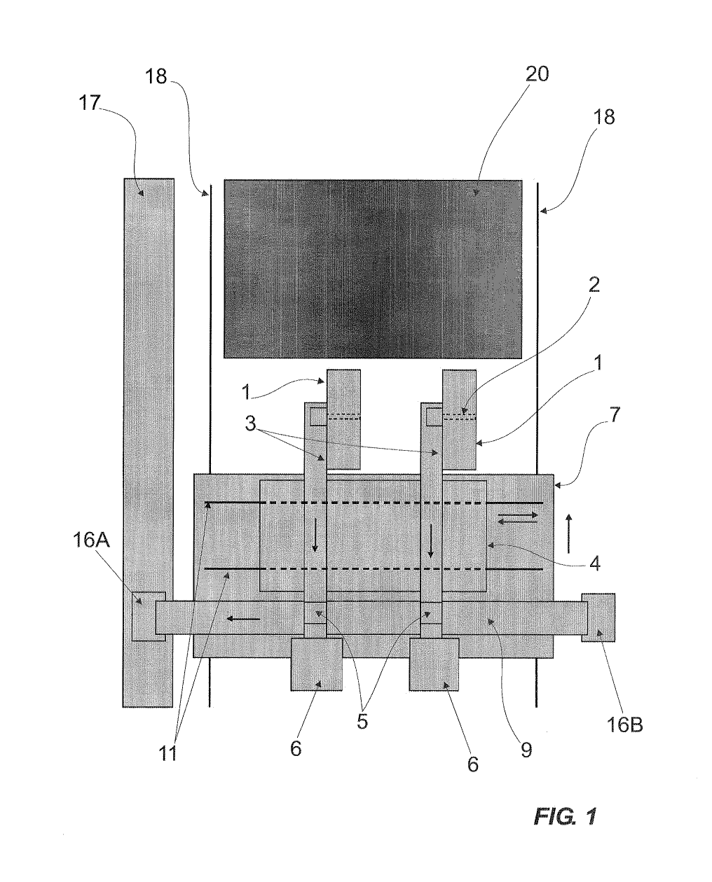

Based on the various aspects of the current invention illustrated on FIGS. 1 to 3, the reclaimer machine 100 may include a bucket wheel 1 having a series of buckets 8 rotating around a shaft 2, driven by an engine and reducer (not illustrated), or by driving force (torque), for example, from a hydraulic engine. The bucket wheel 1 may be connected to a conveyor belt structure 3, which holds the bucket wheel 1 and may also be connected to a transfer chute 5.

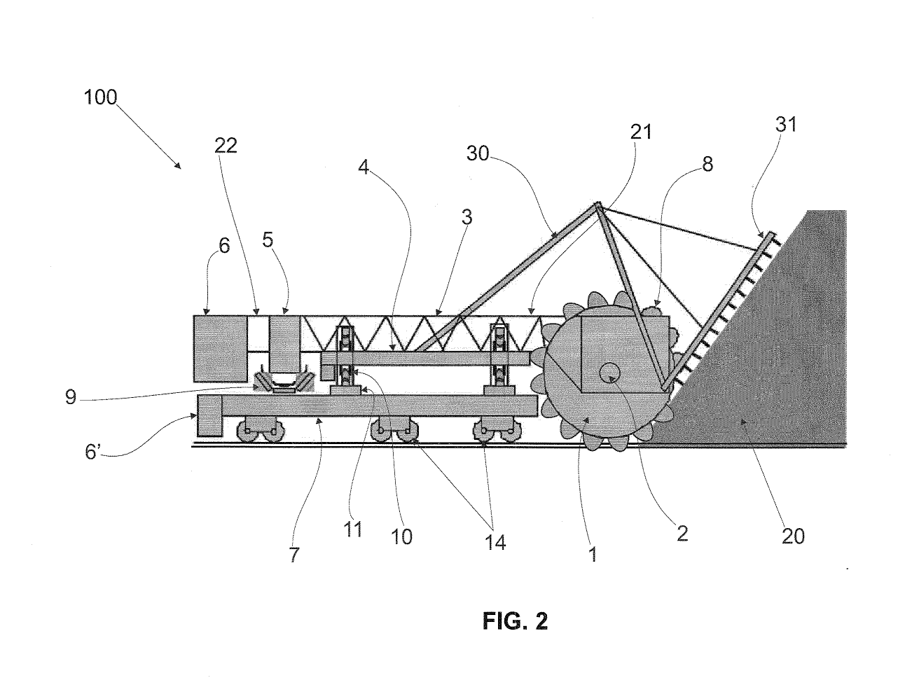

FIG. 1 is a schematic view of a reclaimer machine according to various aspects of the current invention, and FIG. 2 is a side view of an aspect of a reclaimer machine according to various aspects of the current invention. A rake-type supporting structure 30 may be connected to the conveyor belt structure 3 which holds a counterweight 6. This structure 30 may comprise a rake 31 with scarificators pointed towards the pile 20 or stack, aimed at dismantling the pile 20. All of these structural connections may vary according to specific parameters of development of a particular project.

The conveyor belt structure 3 may be supported by an upper platform 4. This upper platform may be placed over at least a pair and preferably two pairs of wheel sets 10, which may move laterally to the pile 20, on tracks 11 attached to a lower platform 7. The lateral movement with regard to the pile of platform 4 may be driven by, but not limited to, motor bogies, chain and pinion or hydraulic or pneumatic systems. The lower platform 7 may be driven by motor bogies 14 in order to support the upper platform 4 and all of the machine's upper portion. Depending on the capacity and on the requirements, both upper 4 and lower 7 platforms can be structured with box girders or lattice bridge, designed to decrease the weight of the whole structure.

The first end 21 of the conveyor belt structure 3 may be connected to the bucket wheel 1. The other end 22 of the conveyor belt structure 3 may be connected to a counterweight 6, which helps balance the machine 100 against its own weight and also additional weight when the buckets 8 are loaded with material from the pile 20.

A second counterweight 6′ may be placed in the lower platform 7, at the opposite end of the bucket wheel 1, in order to balance the lower platform 7 when the buckets 8 are loaded.

According to various aspects, the counterweights may allow the use of the support structure (bridge) only in the central part of the reclaimer machine 100, thus eliminating the need for use a support structure to support the rotation of bucket wheel 1 and lateral movement of the upper 4 and lower 7 platforms. In this case, all the support of the front part of the reclaimer machine 100—the bucket wheel 1 and buckets 8—is sustained in the balance configuration from a central axis. Therefore, this configuration also enables the use of a conveyor belt structure 3 that is external to the bucket wheel 1.

According to various aspects, the bucket wheel 1 may be driven by a driving force (torque) that may be provided by an engine, with or without a frequency inverter for speed variation, as well as a speed reducer and/or any other device, such as a hydraulic motor, connected to a shaft 2 in order to drive the wheel 1. The material from the pile 20 is reclaimed/loaded by the buckets 8 through the rotation of the wheel 1, and then dumped in the conveyor belt placed in the conveyor belt structure 3 that is external to the bucket wheel 1. The lateral movement/translation of the upper platform 4 in relation to the pile 20 of material to be loaded allows for an effective and homogenous handling of the pile 20.

According to various aspects, the conveyor belt structure 3 conveys the loaded material up to the transfer chute 5, which transfers or unloads it onto the reversible conveyor 9 attached to the lower platform 7. Aimed at flow sequence and transportation of the material in the yard conveyor 17, the reversible conveyor 9 unloads the material into other chutes, namely 16A and 16B, depending on the direction of the machine flow.

According to various aspects, the lateral movement/translation of the upper platform 4 in relation to the pile 20 may be driven in different ways, for example using motor-driven wheel sets 10, chain or hydraulic cylinders.

In addition to the bucket wheel 1 spin movement and the lateral translation/movement of the upper platform 4, the lower platform 7 moves in a longitudinal way towards the yard (straightforward in relation to the pile) by means of motor bogies 14.

All of the reclaimer machine 100 components and structures, as well as their respective composing items, may move in line with the lower platform 7 and the motor bogies 14.

The bucket wheel 1, the conveyor belt structure 3, the transfer chute 5 and the counterweight 6 make up a structural set which moves while connected to the upper platform 4. The structural set can be arranged according to several configurations, with different components and quantities depending on how the reclaimer machine 100 is to be used.

According to the needs and interests of the project, any dynamic part of the machine can have variable speed. In addition, in order to reverse the reclaimer's direction, the machine may include the installation of a system at the ends of the yard so as to allow for the machine to rotate 180° using a specific car/platform.

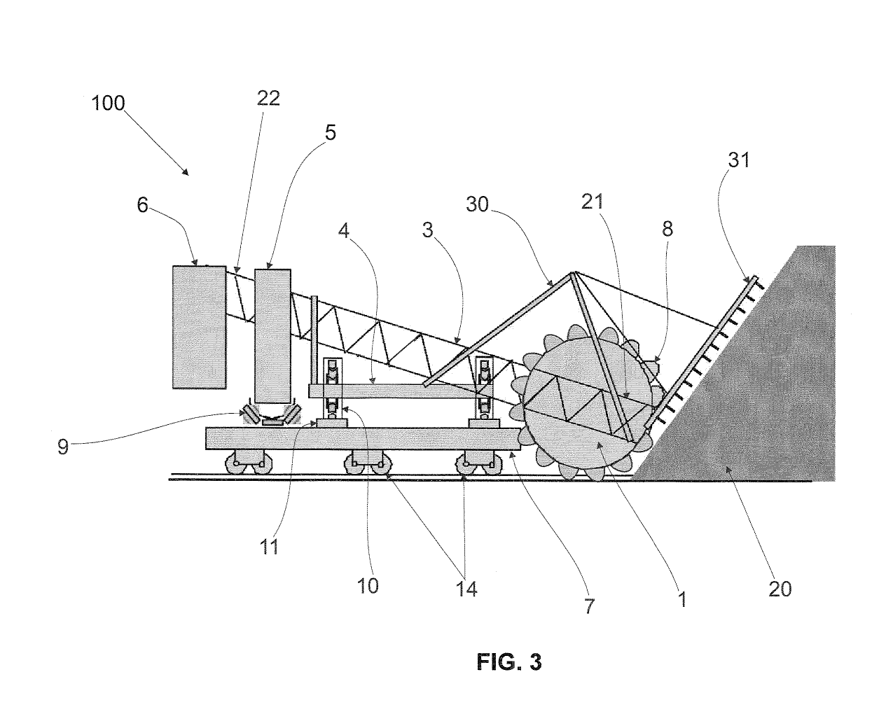

FIG. 3 is a side view of an aspect of a reclaimer machine according to various aspects of the current invention. Based on this aspect, the reclaimer machine 100 may include the same components and functions described in the previous configuration. However, the first conveyor belt 3 may be inclined at an angle, and both the transfer chute 5 and the counterweight 6 are bigger and more suitable to fit the belt's incline. The other described functions may remain the same as with respect to FIGS. 1 and 2 described above.

Some of the advantages of the reclaimer machine 100, as compared against similar known machines, may include one or more of the following:

### General Advantages

The described aspects may provide one or more of the following:

Considerably simplified general maintenance and higher life cycle components and subsets when compared with those used in machines for the same purpose although with a different design;

Simplicity regarding mechanical, structural and electric/electronic components;

Possibility of standardizing the components of, but not limited to, the bucket wheel and its driving system, according to other likewise uniquely-designed machines such as the Bucket Wheel Reclaimer;

Reduced risks of personal accidents due to simplified maintenance;

Reduced costs with general components and spare parts;

Use of bridge, robust box girders, structural arch for supporting the bucket wheels or drums, which hold a history of high incidence of cracks as well as structural collapse risks during life cycle, becomes unnecessary;

Compared with conventional reclaiming devices, misalignments due to forward movement from one end to the other are decreased due to the platform-type horizontal structure, which provides higher horizontal stability for the machine's structure;

The access for handling and lifting cargo is improved, specially from the bucket wheel, since there is no structure on top of the bucket wheel, in opposition to currently available machines, in which there is a bridge (box girder) over the bucket wheel or drum; and

The use of docks for maintenance is facilitated since aspects of the reclaimer machine of the current invention are not as tall as the conventional reclaimer machines.

### Advantages With Respect To Conventional Bridge-Type Bucket Reclaimers

The described aspects may provide one or more of the following:

Use of spin, guiding rolls and/or supporting rolls bearing becomes unnecessary (a component that in addition to being special and of great diameter is also expensive in terms of acquisition and replacement);

Ease of maintenance (bucket wheels can be removed without interfering with components, such as the conveyor belt, bearings, shaft or drivers as is the case with currently available machines);

Easier access for inspection and maintenance along the whole conveyor belt used in the machine;

Easier access for inspection of the bucket wheel's bearing and simplicity regarding removal/disassembly of bucket wheel(s);

Use of rack and pinion to spin the bucket wheel becomes unnecessary;

Lateral movement of the mobile upper platform, using chain or even a hydraulic cylinder;

Reduced overall cost;

Simplicity of construction and manufacturing; and

Operational simplicity;

### Advantages With Respect To Conventional Drum Reclaimers

The described aspects may provide one or more of the following:

Use of a drum (high manufacture, transportation and maintenance costs, expensive life cycle due to higher level of effort as a result of its constructive form) becomes unnecessary;

Use of bridge, robust box girders or structural arch for supporting the bucket wheels or drums, which hold a history of high incidence of cracks as well as structural collapse risks during life cycle, becomes unnecessary;

Use of supporting rolls becomes unnecessary;

Use of spin tracks becomes unnecessary;

Use of guiding rolls becomes unnecessary;

Use of rack and pinion to spin the bucket wheel becomes unnecessary;

Use of the drum's spin drivers, which require synchronism and have a high maintenance rate and a number of components, becomes unnecessary;

Elimination of risks and occurrences of clogging on the drum's internal conveyor, since in the design according to aspects of the current invention, the conveyor used may be placed externally to the buckets, and is thus not being affected by pile discharge and providing ease of access for inspections;

Decreased general maintenance due to reduced number of components and the use of higher life cycle components if compared with current designs;

Use of components and systems intended for moving the rakes, which increase maintenance and manufacture costs, becomes unnecessary;

Elimination of risks related to cracks and structural collapses in the drum, which is subject to great effort due to bending and twisting moments;

The machine can alternatively operate without one of the wheels (in the case of maintenance or any other problem); and

The axial movement is shorter when, for example, operating with three bucket wheels on the platform reclaimer, thus allowing for the wheels to work less time on axial load.

While this invention has been described in conjunction with the exemplary aspects of a reclaimer machine outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

1. A reclaimer machine comprising:
a bucket wheel that includes one or more buckets rotating around a shaft; and
a conveyor belt connected to the bucket wheel and to a transfer chute, the conveyor belt being supported by a mobile upper platform that is arranged on tracks and that is attached to a mobile lower platform, the mobile upper platform being configured to move laterally towards a pile of material via the tracks;
wherein a first end of the conveyor belt structure is connected to the bucket wheel and another end of the conveyor belt structure is coupled to a first counterweight that maintains a balance of the reclaimer machine and supports the bucket wheel and upper platform movements.

2. The reclaimer machine according to claim 1, further comprising a second counterweight coupled to the lower platform at an opposite end of the bucket wheel to balance the lower platform when the one or more buckets are loaded.
